(19) United States
(12) Patent Application Publication
(10) Pub. No.: US 2014/0344482 A1
(43) Pub. Date: Nov. 20, 2014

(54) ELECTRONIC DEVICE AND METHOD FOR MONITORING TEMPERATURE OF HARD DISK DRIVES

(71) Applicants: Hon Hai Precision Industry Co., Ltd., New Taipei (TW); Hong Fu Jin Precision Industry (ShenZhen) Co., Ltd., Shenzhen (CN)

(72) Inventors: CHANG-QUAN HU, Shenzhen (CN); JIAN-FENG GUO, Shenzhen (CN)

(73) Assignees: Hon Hai Precision Industry Co., Ltd., New Taipei (TW); Hong Fu Jin Precision Industry (ShenZhen) Co., Ltd., Shenzhen (CN)

(21) Appl. No.: 14/093,629

(22) Filed: Dec. 2, 2013

(30) Foreign Application Priority Data
May 17, 2013 (CN) 2013101835475

(51) Int. Cl. G06F 11/30

(52) U.S. Cl. CPC G06F 11/3034; G06F 11/3031
USPC 710/19

(57) ABSTRACT

An electronic device includes a hard disk backboard, a plurality of hard disk drives (HDDs) electrically connected to the hard disk backboard, a Serial Attached SCSI (SAS) expander electronically connected to the hard disk backboard, and a Baseboard Management Controller (BMC) electronic connected to the SAS expander. The SAS expander obtains temperature information of the plurality of HDDs and transmits the temperature information to the BMC. A method for monitoring temperature of HDDs in an electronic device is also provided.

### REFERENCE TO RELATED APPLICATIONS

This application claims all benefits accruing under 35 U.S.C. §119 from China Patent Application No. 201310183547.5, filed on May 17, 2013 in the State Intellectual Property Office of China. The contents of the China Application are hereby incorporated by reference.

### BACKGROUND

1. Technical Field

The disclosure generally relates to electronic devices, and particularly relates to electronic devices having multiple hard disk drives.

2. Description of Related Art

A server computer often includes large number of hard disk drives (HDDs) installed in a casing. If the temperature of the HDDs exceeds an operating temperature limit, the computer system may break down (for example, a blue screen may appear). If a user continues to operate the server computer and the HDDs are kept on, data in the HDDs may be lost and the HDDs may be physically damaged.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a block diagram of one embodiment of an electronic device.

FIG. 2 is a block diagram of another embodiment of an electronic device.

FIG. 3 is a flowchart of one embodiment for obtaining temperature information of HDDs.

FIG. 4 is a flowchart of one embodiment for determining an optimal collecting frequency.

FIG. 5 is a flowchart of one embodiment for transmitting temperature information of the HDDs to the BMC.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

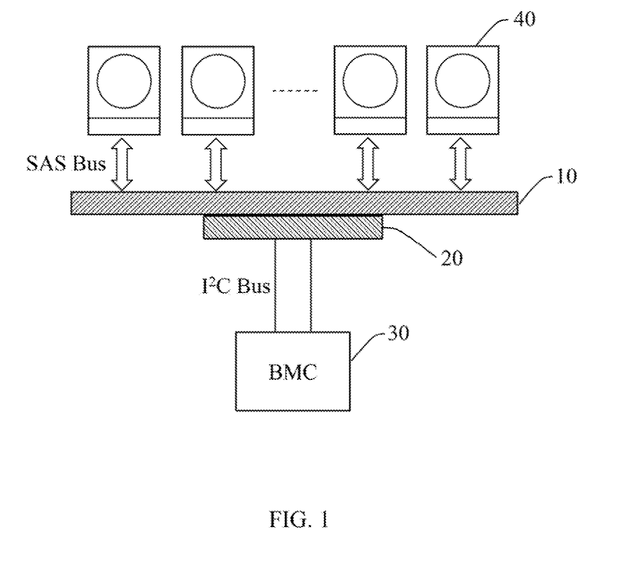

FIG. 1 is a block diagram of one embodiment of an electronic device. The electronic device includes a hard disk backboard 10, a Serial Attached SCSI (SAS) expander 20, a Baseboard Management Controller (BMC) 30, and a plurality of hard disk drives (HDDs) 40. The plurality of HDDs 40 is electronically connected to the hard disk backboard 10 via SAS buses. The SAS expander 20 is electronically connected to the hard disk backboard 10. The BMC 30 is electronically connected to the SAS expander 20 via an Inter-integrated Circuit (I²C, also referred to as I-squared-C, I-two-C, or IIC) bus.

The BMC 30 is a specialized microcontroller embedded on a motherboard of a server. The BMC 30 manages an interface between system management software and platform hardware. The BMC 30 can collect state information of the platform hardware and send the state information to the system management software. The system management software can also communicate with the BMC 30 to take some actions to monitor or configure the platform hardware.

The I²C bus is a multi-master serial single-ended computer bus for attaching low-speed peripherals to a motherboard, embedded system, cellphone, or other electronic device. The I²C bus includes two bidirectional open-drain lines, a Serial Data Line (SDL) and a Serial Clock Line (SCL), pulled up with resistors.

The SAS expander 20 facilitates communication between the plurality of HDDs 40 and the BMC 30. The SAS expander 20 includes a Serial SCSI Protocol target port for access to the plurality of HDDs 40.

The SAS expander 20 may obtain temperature information of the HDD 40 from a Self-Monitoring Analysis and Reporting Technology (S.M.A.R.T.) module of the HDD 40.

The SAS expander 20 may obtain the number of the HDDs 40 connected to the hard disk backboard 10 and calculate a proposed collecting frequency according to the number of the HDDs 40. The SAS expander 20 may send the proposed collecting frequency to the BMC 30 through the I²C bus.

The BMC 30 may receive a user specified collecting frequency from a user via a user interface. The BMC 30 compares the proposed collecting frequency with the user specified collecting frequency. If the proposed collecting frequency is greater than the user specified collecting frequency, the BMC 30 selects the proposed collecting frequency as an optimal collecting frequency. If the user specified collecting frequency is greater than the proposed collecting frequency, the BMC 30 selects the user specified collecting frequency as an optimal collecting frequency.

When the optimal collecting frequency is determined by the BMC 30, the BMC 30 sends the optimal collecting frequency to the SAS expander 20 via the I²C bus. The SAS expander 20 may obtain the temperature information from the HDDs 40 at the optimal collecting frequency.

The SAS expander 20 may also monitor whether the number of the HDDs 40 has changed. When the number of the HDDs 40 has changed, the SAS expander 20 may re-calculate a new proposed collecting frequency according to the new number of the HDDs 40 and send the new proposed collecting frequency to the BMC 30 via the I²C bus. The BMC 30 may determine a new optimal collecting frequency by comparing the new proposed collecting frequency with the user specified collecting frequency and send the new optimal collecting frequency to the SAS expander 20. The SAS expander 20 may obtain the temperature information of the HDDs 40 at the new optimal collecting frequency.

When the SAS expander 20 has obtained the temperature information of the HDDs 40, the SAS expander 20 may send a data-ready message to the BMC 30 via the I²C bus. The data-ready message may include the number of the HDDs 40 and a data length of the temperature information of the HDDs 40.

In response to receiving the data-ready message, the BMC 30 performs some actions to prepare to receive the data from the SAS expander 20. For example, the BMC 30 designates a storage area to store the data sent from the SAS expander 20 according to the data length indicated by the data-ready message. After that, the BMC 30 may send a receive-ready message to the SAS expander 20 via the I²C bus.

When the SAS expander 20 has received the receive-ready message from the BMC 30, the SAS expander 20 may send the temperature information of the HDDs 40 to the BMC 30 via the I²C bus.

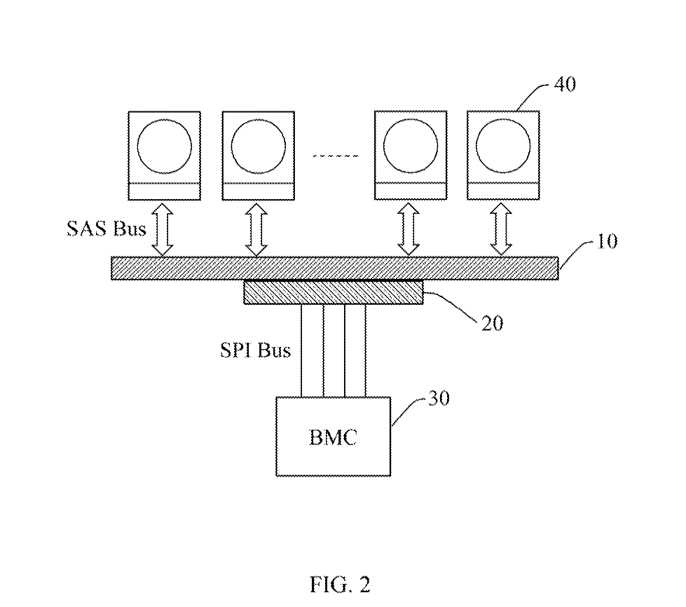

FIG. 2 shows another embodiment of the electronic device. The BMC 30 is electronically connected to the SAS expander 20 via a Serial Peripheral Interface (SPI) bus. The SPI bus is a synchronous serial data link de facto standard that operates in full duplex mode. The SPI bus includes a CS line, an SCL line, an MOS line, and an MIS line. In other embodiments, the BMC 30 may be electronically connected to the SAS expander 20 via other type of bus.

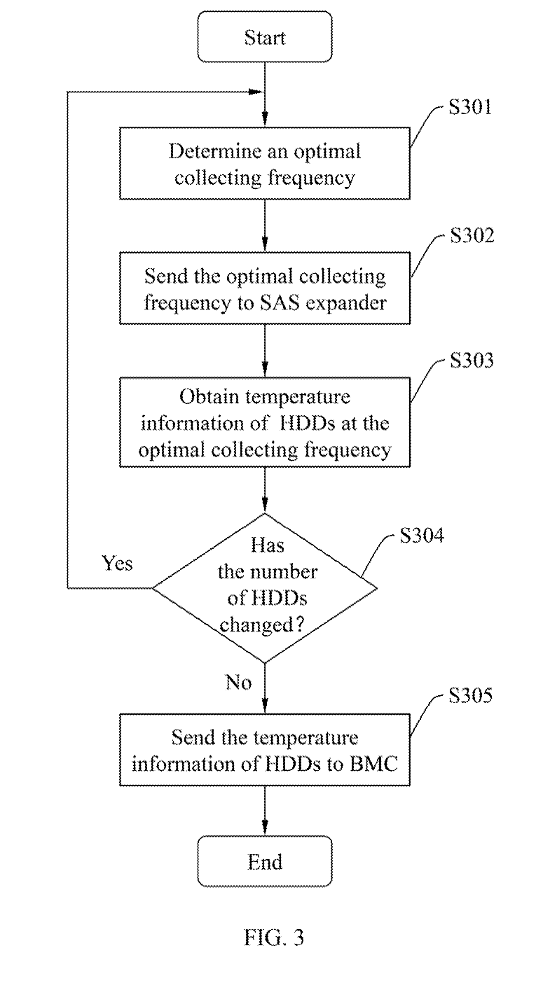

FIG. 3 shows a flowchart of one embodiment of a method for obtaining temperature information of HDDs. The method includes the following steps.

In step S301, the BMC 30 determines an optimal collecting frequency.

In step S302, the BMC 30 sends the optimal collecting frequency to the SAS expander 20.

In step S303, the SAS expander 20 obtains temperature information of the HDDs 40 at the optimal collecting frequency.

In step S304, the SAS expander 20 monitors whether the number of the HDDs 40 connected to the hard disk backboard 10 has changed. If the number of the HDDs 40 has changed, the flow goes to step S301 and the BMC determines a new optimal collecting frequency. If the number of the HDDs 40 remains unchanged, the flow proceeds to step S305.

In step S305, the SAS expander 20 sends the temperature information of the HDDs 40 to the BMC 30.

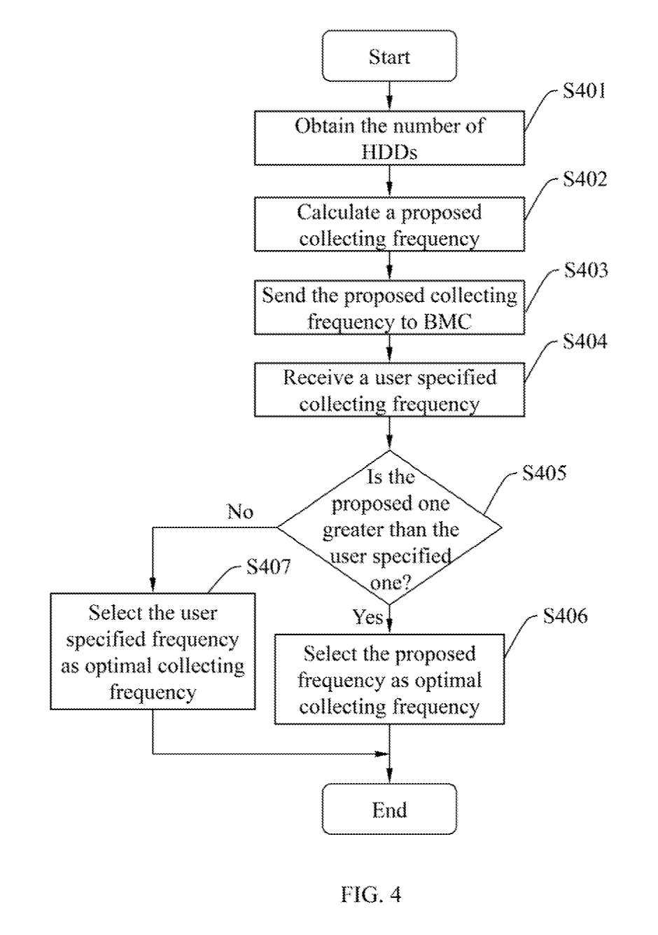

FIG. 4 shows a flowchart of one embodiment of a method for determining an optimal collecting frequency. The method includes the following steps.

In step S401, the SAS expander 20 obtains the number of the HDDs 40 connected to the hard disk backboard 10.

In step S402, the SAS expander 20 calculates a proposed collecting frequency according to the number of the HDDs 40.

In step S403, the SAS expander 20 sends the proposed collecting frequency to the BMC 30.

In step S404, the BMC 30 receives a user specified collecting frequency from a user via a user interface.

In step S405, the BMC 30 compares the proposed collecting frequency with the user specified collecting frequency. If the proposed collecting frequency is greater than the user specified collecting frequency, the flow proceeds to step S406. If the user specified collecting frequency is greater than the proposed collecting frequency, the flow proceeds to step S407.

In step S406, the BMC 30 selects the proposed collecting frequency as the optimal collecting frequency.

In step S407, the BMC 30 selects the user specified collecting frequency as the optimal collecting frequency.

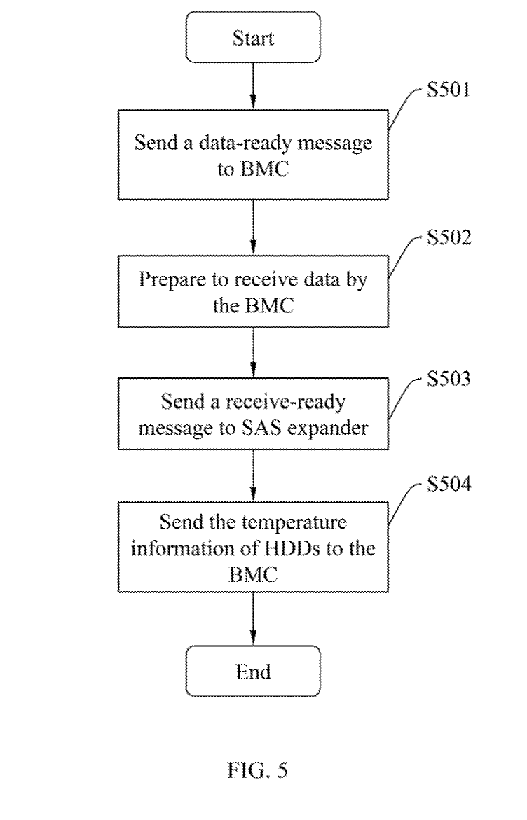

FIG. 5 shows a flowchart of one embodiment of a method for transmitting temperature information of the HDDs 40 to the BMC 30. The method includes the following steps.

In step S501, the SAS expander 20 sends a data-ready message to the BMC 30. The data-ready message includes the number of the HDDs 40 and a data length of the temperature information of the HDDs 40.

In step S502, the BMC 30 performs some actions to prepare to receive the data from the SAS expander 20. For example, the BMC 30 designates a storage area to store the data sent from the SAS expander 20 according to the data length indicated by the data-ready message.

In step S503, the BMC 30 sends a receive-ready message to the SAS expander 20.

In step S504, the SAS expander 20 sends the temperature information of the HDDs 40 to the BMC 30.

Although numerous characteristics and advantages have been set forth in the foregoing description of embodiments, together with details of the structures and functions of the embodiments, the disclosure is illustrative only, and changes may be made in detail, especially in the matters of arrangement of parts within the principles of the disclosure to the full extent indicated by the broad general meaning of the terms in which the appended claims are expressed.

In particular, depending on the embodiment, certain steps or methods described may be removed, others may be added, and the sequence of steps may be altered. The description and the claims drawn for or in relation to a method may give some indication in reference to certain steps. However, any indication given is only to be viewed for identification purposes, and is not necessarily a suggestion as to an order for the steps.

What is claimed is:

1. An electronic device, comprising:
a hard disk backboard;
a plurality of hard disk drives (HDDs) electrically connected to the hard disk backboard;
a Serial Attached SCSI (SAS) expander electronically connected to the hard disk backboard; and
a Baseboard Management Controller (BMC) electronic connected to the SAS expander;
wherein the SAS expander is configured for obtaining temperature information of the plurality of HDDs and transmitting the temperature information to the BMC.

2. The electronic device of claim 1, wherein the BMC is configured for determining an optimal collecting frequency and sending the optimal collecting frequency to the SAS expander, the SAS expander is configured for obtaining the temperature information of the plurality of HDDs at the optimal collecting frequency.

3. The electronic device of claim 2, wherein the SAS expander is configured for obtaining a number of the plurality of HDDs connected to the hard disk backboard, calculating a proposed collecting frequency according to the number of the plurality of HDDs, and sending the proposed collecting frequency to the BMC.

4. The electronic device of claim 3, wherein the BMC is configured for receiving a user specified collecting frequency via a user interface, and selecting from the specified collecting frequency and the proposed collecting frequency as the optimal collecting frequency.

5. The electronic device of claim 4, wherein the BMC is configured for comparing the user specified collecting frequency with the proposed collecting frequency; when the proposed collecting frequency is greater than the user specified collecting frequency, the BMC is configured for selecting the proposed collecting frequency as the optimal collecting frequency; when the user specified collecting frequency is greater than the proposed collecting frequency, the BMC is configured for selecting the user specified collecting frequency as the optimal collecting frequency.

6. The electronic device of claim 5, wherein the SAS expander is configured for detecting when the number of the plurality of HDDs has changed; when the number of the plurality of HDDs has changed, the SAS expander is configured for calculating a new proposed collecting frequency and sending the new proposed collecting frequency to the BMC, the BMC is configured for comparing the user specified collecting frequency with the new proposed collecting frequency and selecting a large of the new proposed collecting frequency and the user specified collecting frequency as a new optimal collecting frequency.

7. The electronic device of claim 1, wherein the SAS expander is configured for sending a data-ready message to the BMC when the SAS expander has obtained the temperature information of the plurality of HDDs.

8. The electronic device of claim 7, wherein the data-ready message comprising the number of the plurality of HDDs and a data length of the temperature information of the plurality of HDDs.

9. The electronic device of claim 8, wherein the BMC is configured for sending a receive-ready message to the SAS expander when the BMC is ready for receiving data from the SAS expander.

10. The electronic device of claim 9, wherein the SAS expander is configured for sending the temperature information of the plurality of HDDs to the BMC when the SAS expander has received the receive-ready message from the BMC.

11. A method for monitoring temperature of HDDs in an electronic device, the method comprising:
connecting a plurality of hard disk drives (HDDs) to a hard disk backboard;
connecting a Serial Attached SCSI (SAS) expander to the hard disk backboard;
connecting a Baseboard Management Controller (BMC) to the SAS expander;
obtaining temperature information of the plurality of HDDs by the SAS expander; and
transmitting the temperature information to the BMC by the SAS expander.

12. The method of claim 11, further comprising:
determining an optimal collecting frequency by the BMC;
sending the optimal collecting frequency to the SAS expander by the BMC; and
obtaining the temperature information of the plurality of HDDs at the optimal collecting frequency by the SAS expander.

13. The method of claim 12, further comprising:
obtaining a number of the plurality of HDDs connected to the hard disk backboard;
calculating a proposed collecting frequency according to the number of the plurality of HDDs by the SAS expander; and
sending the proposed collecting frequency to the BMC by the SAS expander.

14. The method of claim 13, further comprising:
receiving a user specified collecting frequency via a user interface by the BMC; and
selecting one of the specified collecting frequency and the proposed collecting frequency as the optimal collecting frequency by the BMC.

15. The method of claim 14, further comprising:
comparing the user specified collecting frequency with the proposed collecting frequency by the BMC;
when the proposed collecting frequency is greater than the user specified collecting frequency, selecting the proposed collecting frequency as the optimal collecting frequency by the BMC; and
when the user specified collecting frequency is greater than the proposed collecting frequency, selecting the user specified collecting frequency as the optimal collecting frequency by the BMC.

16. The method of claim 15, further comprising:
detecting when the number of the plurality of HDDs has changed by the SAS expander;
when the number of the plurality of HDDs has changed, calculating a new proposed collecting frequency and sending the new proposed collecting frequency to the BMC by the SAS expander;
determining a new optimal collecting frequency by comparing the user specified collecting frequency with the new proposed collecting frequency; and
selecting a large of the new proposed collecting frequency and the user specified collecting frequency as a new optimal collecting frequency.

17. The method of claim 11, further comprising sending a data-ready message to the BMC by the SAS expander when the SAS expander has obtained the temperature information of the plurality of HDDs.

18. The method of claim 17, wherein the data-ready message comprising the number of the plurality of HDDs and a data length of the temperature information of the plurality of HDDs.

19. The method of claim 18, further comprising sending a receive-ready message to the SAS expander by the BMC when the BMC is ready for receiving data from the SAS expander.

20. The method of claim 19, further comprising sending the temperature information of the plurality of HDDs to the BMC by the SAS expander when the SAS expander has received the receive-ready message from the BMC.
